(19) United States
(12) Patent Application Publication
(10) Pub. No.: US 2011/0104972 A1
(43) Pub. Date: May 5, 2011

(54) PROTECTIVE BARRIER HAVING SELF-DECONTAMINATING PROPERTIES

(75) Inventor: Song Liu, Winnipeg (CA)

(73) Assignee: University of Manitoba, Winnipeg, MB (CA)

(21) Appl. No.: 12/937,699

(22) PCT Filed: Apr. 14, 2009
(86) PCT No.: PCT/CA2009/000488

§ 371 Date: Dec. 31, 2010

Related U.S. Application Data
(60) Provisional application No. 61/044,897, filed on Apr. 14, 2008.

(51) Int. Cl. B32B 5/18; B05D 3/00

(52) U.S. Cl. 442/221; 428/319.3; 427/331

(57) ABSTRACT

A protective material includes a porous substrate having cross-linked self-decontaminating polymer grafted thereon, the cross-linked self-decontaminating polymer having been converted after grafting to activate self-decontaminating function. The cross-linked self-decontaminating polymer provides the protective material with reversible swelling ability to block the porous substrate when the protective barrier is contacted by liquids.

### TECHNICAL FIELD

The present invention relates to a protective barrier having self-decontaminating properties, in particular, a protective barrier having self-decontaminating properties for protection against biological and chemical contaminating agents.

### BACKGROUND

Protective clothing is designed to shield professionals such as healthcare workers, soldiers and first responders, for example, from exposure to potential hazards such as: bacteria, viruses, fungi, yeasts, spores and toxic chemicals such as carbamate pesticides, for example.

Currently, protective clothing is made of barrier textile materials that completely block penetration and permeation of chemical solutions or human fluids through the fabric. Although efficient at protecting wearers from potential hazards, the barrier properties of the protective clothing impede the transport of heat and moisture that is generated by wearers. This often results in worker heat stress and low work efficiency.

In addition, although biological and chemical agents on the contaminated clothing may not penetrate the fabric, they remain on the clothing. As such, the potential of cross infection due to agents such as pathogens, for example, becomes a serious hazard.

It is therefore desirable to provide a protective barrier that obviates or mitigates the above disadvantages.

### SUMMARY OF THE INVENTION

According to an embodiment of the present invention there is provided a protective material including:

cross-linked self-decontaminating polymer grafted on a porous substrate, the cross-linked self-decontaminating polymer having been converted after grafting to activate self-decontaminating function;

wherein the cross-linked self-decontaminating polymer reversibly swells to block the porous substrate when the protective material is contacted by liquids.

According to an embodiment of the present invention there is provided a method for producing a protective material including:

providing a substrate, the substrate having a porous structure;

introducing a functional group into the substrate;

immobilizing a co-initiator onto the substrate;

grafting cross-linked self-decontaminating polymer onto the substrate, the cross-linked self-decontaminating polymer being grafted in a manner that maintains the porous structure of the substrate; and

converting the cross-linked self-decontaminating polymer into an acyclic N-halamine to activate self-decontaminating function of the protective material;

wherein the cross-linked self-decontaminating polymer is a responsive polymer having reversible swelling ability.

According to an embodiment of the present invention there is provided a protective material including:

a porous substrate having converted cross-linked polymer grafted thereon to provide the protective material with reversible swelling ability to vary the permeability of the protective barrier in response to changing hydration of the porous substrate

### BRIEF DESCRIPTION OF THE DRAWINGS

The following figures set forth embodiments of the invention in which like reference numerals denote like parts. Embodiments of the invention are illustrated by way of example and not by way of limitation in the accompanying figures.

FIG. 1 is a schematic diagram showing a portion of a protective material prior to application of a hazardous fluid;

FIG. 2 is a schematic diagram showing the protective material of FIG. 1 following application of a hazardous fluid;

FIG. 3 is a flowchart depicting a method for producing a protective material according to an embodiment of the present invention;

FIG. 4 shows the chemical structure of N-[Tris(hydroxymethyl)methyl]acrylamide (THMA);

FIG. 5 shows the chemical structure of N,N′-methylenebisacrylamide (MBA);

FIG. 6 is a schematic diagram showing the formation of an interpenetration network;

FIG. 7 shows immobilization of synergist initiator;

FIG. 8a shows the formation of a starter radical;

FIG. 8b shows the grafting of cross-linked polyacrylamide; and

FIG. 9 shows the activation of self-decontaminating function on the polyacrylamide grafted fibre.

### DETAILED DESCRIPTION OF EMBODIMENTS OF THE INVENTION

Materials such as textile fabrics, for example, having refreshable self-decontaminating functions including biocidal functions are produced by incorporating precursors of functional agents having the ability to undergo reversible chemical reactions into the materials. One method for providing fabric with biocidal properties is disclosed in U.S. Patent Application No. 2007/0086976, which is herein incorporated by reference.

Precursors of self-decontaminating agents, such as cyclic amides, for example, are incorporated into textile fabrics by covalent bonding and a redox reaction is conducted in the laundry process to activate the function, as shown in Equations 1 and 2.

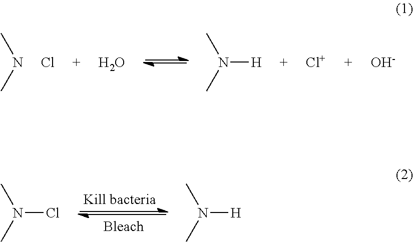

Strong oxidizing agents, such as chlorine bleach, for example, convert precursor cyclic amine to halamines. The halamine structures are reduced to their precursor forms after reacting with biological or chemical agents. Materials incorporating halamine moieties as the functional agent perform similarly to low molecular weight halamine compounds and are therefore effective as protective barriers.

Halamine chemicals are powerful decontaminating agents that are also safe for the human body, which is evidenced by the use of monomeric halamines such as dichloro-5,5-dimethylhydantoin and trichloroisocyanuic acid, for example, in swimming pool disinfection. Halamine structures instantly kill a broad spectrum of pathogens including: bacteria, viruses, fungi, yeasts, spores and toxic chemicals such as carbamate pesticides by either oxidizing sulfahydral bonds in microorganisms or by releasing chlorine to penetrate cell walls. Halamines have demonstrated the potential to detoxify toxic chemicals with an oxidative hydrolysis of the chemicals similar to that caused by chlorine bleach.

Examples of natural and synthetic fabrics that are suitable for use as protective barriers include cotton, polyester, nylon, Nomex™ and Kevlar™, for example. When the precursors to functional agents are incorporated into these materials, any pores in the fabric are blocked in order to avoid penetration through the protective clothing by biological and chemical agents.

Acyclic amine/amide monomers are also used as functional agents in order to provide materials with self-decontamination properties. Acyclic amine/amide monomers are grafted onto fabrics such as cotton, polyester and polypropylene, for example, and converted via bleaching to acyclic N-halamine fabrics. Examples of suitable acyclic amine/amide monomers include: acrylamide and methacrylamide. Similar to cyclic N-halamine, acyclic N-halamine fabrics demonstrate 6 log reduction of E. Coli at a contact time of 15-30 minutes.

In one embodiment of the present invention, a protective barrier includes a porous substrate having cross-linked self-decontaminating polymer grafted thereon and converted in order to activate self-decontaminating function. The cross-linked self-decontaminating polymer provides the protective barrier with reversible swelling ability to block the porous substrate when the protective barrier is contacted by liquids.

Polymerized acyclic amine/amide monomers are used as functional agents in order to provide materials with responsive barrier properties in addition to self-decontamination properties. Polymerized acrylamide forms an environmentally responsive hydrogel having the ability to swell and deswell reversibly. In addition, cross-linked poly(acrylamide-co-acrylic acid) is quick in absorbing body fluids, having the ability to absorb normal saline up to 30 times its original weight in less than 10 seconds.

The cross-linked polyacrylamide is grafted onto a porous substrate such as polyethylene terephthalate (PET), for example, and then the primary amide is converted to acyclic N-halamine in order to activate the self-decontaminating function. Because of its ability to swell reversibly, cross-linked polyacrylamide provides a responsive barrier for materials that include pores provided by weaves, loops or voids without blocking the pores during normal wearing conditions.

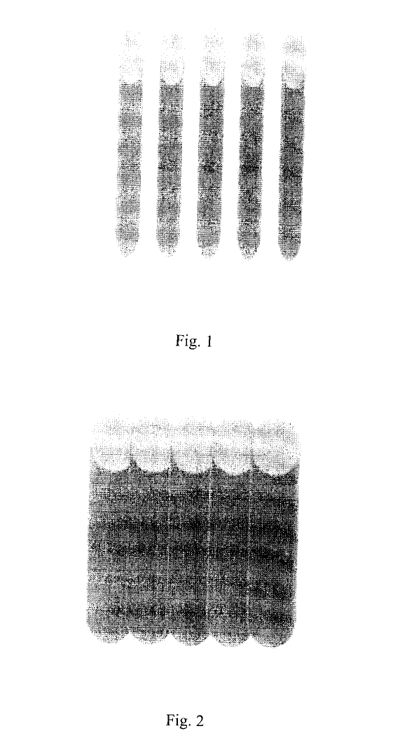

Porous protective clothing is more comfortable for the wearer because the pores provide breathability. As shown to FIG. 1, under normal conditions, grafted polymers collapse to remain the porous structure of the base material. When in contact with fluids, the grafted polymer network swells, as shown in FIG. 2, to both hold the fluids and block to pores of the base fabric. Thus providing a “smart” protective barrier having the ability to swell to block penetration by fluids to protect the wearer and at the same time hold and disinfect the fluids to reduce cross-infection. In addition to having the ability to swell to block penetration by fluids, the protective barrier also has the ability to vary the permeability in response to the degree of hydration. Therefore, the grafted polymer network includes not only swollen and non-swollen states but also at least one partially swollen state.

Polyacrylamide and its copolymer poly(acrylamide-co-acrylate) have been proven to be safe to humans. When tested under conditions representing spilling of polyacrylamide product on clothing, only mild skin irritation was noted. Polyacrylamides are used safely for numerous indirect food packaging applications, potable water and direct food applications.

Protective barriers for clothing are primarily made from synthetic clothing such as polypropylene and polyester, for example, which do not have any functional groups. The inert chemical structure of synthetic fibres makes it difficult to introduce useful properties such as antistatic and antimicrobial via chemical modification methods. Radical graft polymerization is used to impart durable functions into the synthetic fibres, however, this chemical method produces a homopolymerization side reaction. One solution to this problem is immobilizing macromolecular initiator onto the substrate. Subsequent addition of a polymerizable monomer with heat or light then produces a graft efficiently. Typically, the substrate polymer is oxidized or otherwise modified so that radicals or radical precursors are generated at the surface. The yields of these immobilization reactions, however, are low due to the inert structure of the synthetic fibers and the difficulty of the chemical reaction.

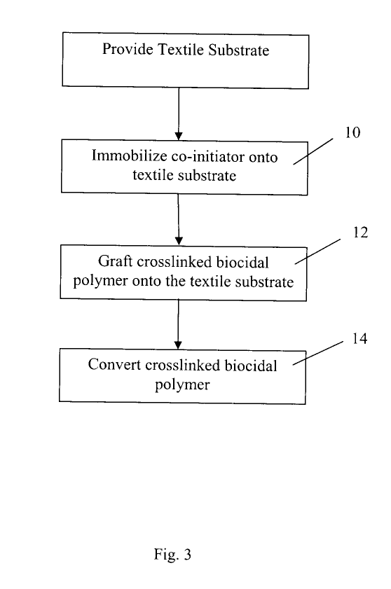

Referring to FIG. 3, a method for imparting functionality onto a substrate is generally shown. First, functional group is introduced into the substrate to allow co-initiator to be immobilized onto the substrate, as indicated by reference numeral 10. Then the grafting of the cross-linked self-decontaminating polymer, polyacrylamide, is performed, as indicated by reference numeral 12. Finally, activation of self-decontaminating function is performed, as indicated by reference numeral 14.

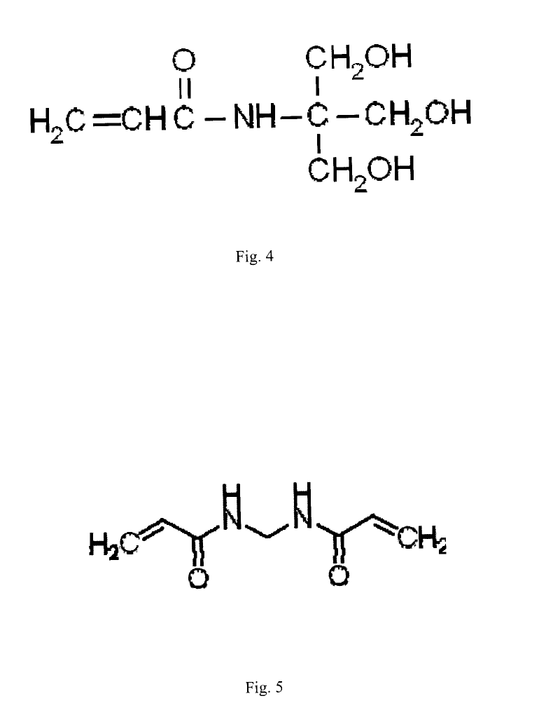

The functional group is introduced into the substrate by forming 3-dimensional interpenetration network of functional polymer and the substrate polymer matrix. Specifically, vinyl monomer having hydroxyl group is used: N-[Tris(hydroxymethyl)methyl]acrylamide (THMA). N,N′-methylenebisacrylamide (MBA) can serve as a crosslinker leading to the formation of a network of polymer chains. The structure of THMA is shown in FIG. 4 and the structure of MBA is shown in FIG. 5. Co-initiator is immobilized onto the substrate by taking advantage of the hydroxyl group on the substrate.

Initiation of grafting reaction on existing polymers depends on free radicals generated on polymer backbones. Initial radicals produced from decomposition of an initiator can have several different reactions with both polymers and monomers in the system. An abstraction of hydrogen from a polymer backbone is the key reaction in grafting functional monomers onto the polymer. An addition of the radical to the monomer in the system is a homopolymerization of the monomer, which has no effect on the functional modifications of the original polymer. Although there are many other possible reactions that the initial radical may go into, the above two reactions are the major competing ones. The abstraction of hydrogen by benzophenone (BP) has been studied extensively. In comparison with the process of thermally initiated grafting with peroxide as the initiator, photoinitiated grafting affords a higher grafting efficiency. Alpha hydrogen of amine group is highly sensitive to hydrogen abstraction by BP. Thus immobilization of N-diethyl amide on the substrate will favor hydrogen abstraction reaction and depress the homopolymerization side reaction. The ethyl substituted amine is called co-initiator, or synergist, for the photoinitiator BP. Degree of add-on and polymer chain length can be well controlled by adjusting the main functionalization parameters (co-initiator concentration, BP concentration, UV irradiation time and monomer concentration).

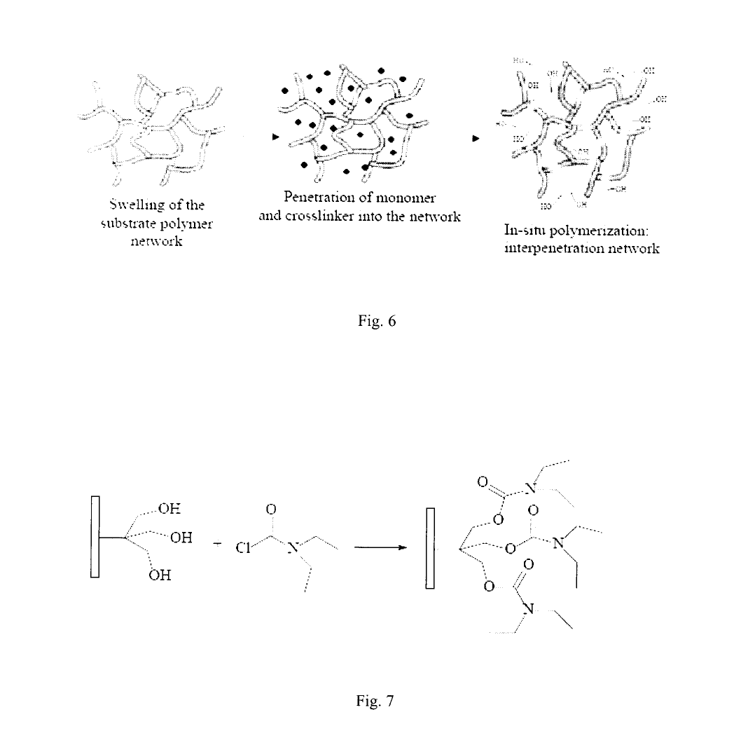

In order to immobilize the co-initiator onto the chemically inert polyester backbone without changing the porous structure of the substrate, a 3-dimensional interpenetration network of poly(N-[tris(hydroxyl methyl)methyl]acrylamide) (PTHMA) and substrate polyester matrix is first formed, as shown in FIG. 6. Unless the base material is dissolved by its good solvent, PTHMA will not be separated from it. N-diethyl substituted amide can hence be introduced into the substrate by reacting 2-Chloro-N,N-diethylacetamide with the hydroxyl groups, as shown in FIG. 7. This approach provides a nondestructive method to immobilize co-initiator onto substrates, the reaction yield of which could be much higher than those traditional methods such as oxidization, for example.

For example, a 30×30 cm fabric swatch is firstly immersed in approximately 50 ml of methanol solution of THMA and MBA for 12 hours. Excess solution is squeezed out by passing the fabric swatch through a wringer to achieve 50-100% add-on of THMA and MBA solution. The fabric is then exposed to UV irradiation (λ>300 nm; intensity 5-40 mW/cm²) for 15-60 minutes, and then extracted with acetone in a Soxhlet-extractor for 72 hours, dried at 60° C. The interpenetration network is formed so that poly(THMA) is physically but durably trapped into the substrate PET. It is possible to calculate the degree of PTHMA add-on based on elemental analysis of nitrogen since it only exists in PTHMA. Squeezing out excess monomer solution in the process can avoid the formation of polymer fabric in the interstices so that porous structure of PET fabric can be retained. Finally, the modified PET fabric is immersed in methanol solution of 2-Chloro-N,N-diethylacetamide to introduce the co-initiator: N-diethyl amide into the substrate (60° C., 0.5-3 hours). The degree of tertiary amide groups grafting can be calculated from the increment of nitrogen content and well controlled by adjusting the main functionalization parameters (THMA concentration, BP concentration and UV irradiation time/intensity) to maximize the efficiency of the following radical grafting reactions.

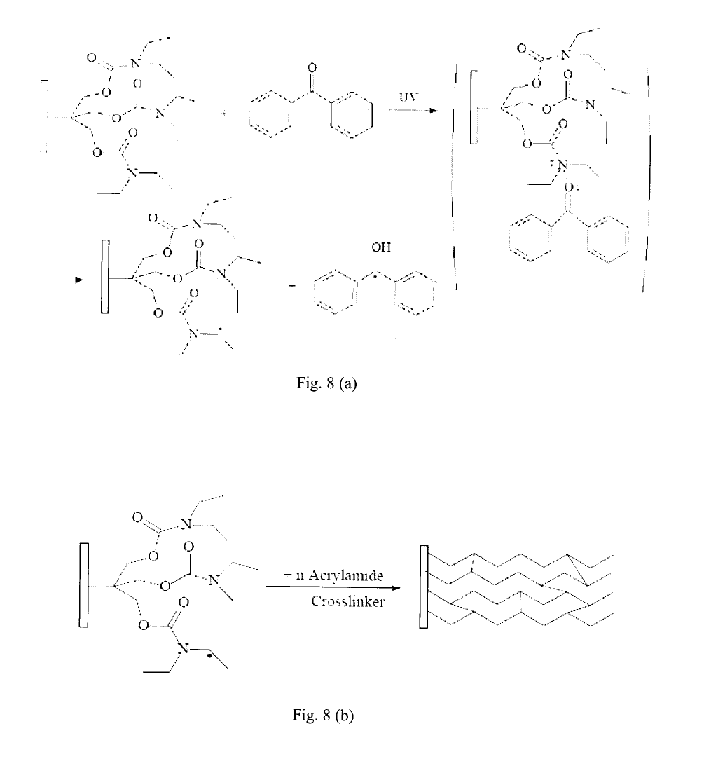

The adsorption of BP onto the polymer surface in a separate step, before UV-initiated graft copolymerization, improves the surface selectively and grafting efficiency considerably. In presence of the co-initiator N-diethyl amide, benzophenone shows high selectivity. Therefore, the starter radical will be generated at alpha hydrogen of amide. With crosslinker N₂N¹-methylenebisacrylamide in the grafting solution, polyacrylamide will be grafted from the substrate and cross-linked in situ, as shown in FIGS. 8(a) and 8(b). N₂N¹-methylenebisacrylamide is a good candidate as crosslinker since it has the similar reactivity ratio with acrylamind in copolymerization. The crosslinking density and degree of grafting is controlled by the monomer/crosslinker concentration and duration of UV irradiation. Since UV irradiation generally does not penetrate through polyester fabric, the graft polymerization is limited to one side of the fabric. This allows the wearing comfort of the modified fabrics to be maintained because the side of the fabric that is in contact with skin remains dry and comfortable at all times.

In one example, the grafting is performed by: providing a UV illumination system equipped with a high-pressure mercury lamp and a glass filter (λ>300 nm; UV intensity in the range of 5-40 mW/cm²). Pre-weighed amidolysed PET fabrics are immersed into 50 mL monomer solution in methanol, containing the photoinitiator BP. After 10 min equilibration, UV irradiation follows. Thereafter, the samples are taken out immediately and washed with water three times (each 30 min, at 60° C.) to remove unreacted monomer, residual initiator and homopolymer. Then, the fabrics are dried in vacuum at 60° C. overnight. The degree of grafting (DG) is determined gravimetrically from the weight of each sample before and after modification through the following equation:

DG=(W₁−W₀)/W₀ (3)

Where W₀ and W₁ represent the samples' weights before and after modification, respectively.

Acid hydrolysis of the grafted polycrylamide generates poly(acrylamide-co-acrylic acid) equivalent grafting. Introduction of acid group imparts increased swelling capacity and saline/pH sensitivity to the grafted polymer network, the degree of which can be controlled by hydrolysis yield. The hydrolysis of amide can also be accomplished in the following chlorination process. Surface morphology and functionality can be analyzed by surface analytical methods such as Scanning Electron Microscopy (SEM), X-ray Phtoelectron spectroscopy (XPS).

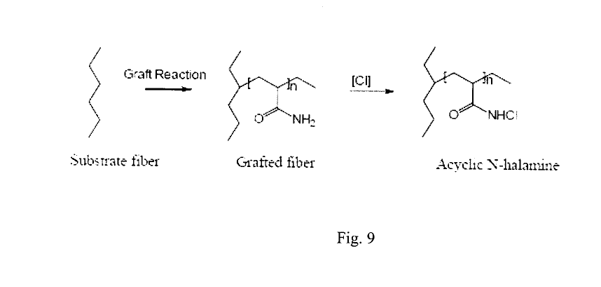

Activation of self-decontaminating function on the polyacrylamide grafted fiber is generally shown in FIG. 9. Conversion of halamine precursor structures in the grafted samples into N-halmines is conducted by immersing the sample in a diluted chlorine bleach solution (300 ppm available chlorine, pH 11) at room temperature for 30 min with stirring (liquor ratio was 1:50). The fabrics are then washed in distilled water and dried at 60° C.

Acyclic N-halmines provide quick and total reduction of E. Coli, however, the hydrolysis of primary amides under the chlorination process greatly affects their ability to be refreshed. At neutral condition with addition of 6% sodium chloride, the chlorine loading can be maximized and hydrolysis minimized. The first time chlorination is carried out at acidic (pH4) or basic (pH11) condition to both convert amide to N-halmine and hydrolyze 5-20% of the primary amide.

The antibacterial function can be evaluated following a modified American Association of Textile Chemist and Colorists (AATCC) test method 100 against a Gram-negative bacterium Escherichia coli (E. Coli) and a Gram-positive bacterium Staphylococcus aureu (S. Aureu). The fabrics are cut into four small pieces (ca.4 cm²), and two pieces of the sample are put together in a sterilized container. 1.0 mL of an aqueous suspension containing 10⁵-10⁶ colony forming units (CFU)/mL of E. Coli is placed onto the surfaces of the fabrics. After variable contact times, the inoculated samples are placed into 100 mL of 0.03% sodium thiosulfate aqueous solutions to neutralize any active chlorine. The mixture is then vigorously shaken for 5 min. An aliquot of the solution is removed from the mixture and then serially diluted and 100 μL of each dilution are placed onto a nutrient agar plate. The same procedure is also applied to the bleached ungrafted and grafted but unbleached cotton as controls. Viable bacterial colonies on the agar plates are counted after incubation at 37° C. for 24 h.

Bacterial reduction is reported according to equation 4:

Percentage reduction of bacteria (%)=(A−B)/A×100 (4)

Where A is the number of bacteria counted from untreated fabrics, and B is the number of bacteria counted from treated fabrics.

Air permeability and water vapor transmission of the modified PET fabric are evaluated as an indication of wearing comfort according to ASTM D737-04 (Standard Test Methods for Air Permeability of Textile Fabrics) and E96-05 (Standard Test Methods for Water Vapor Transmission of Materials) respectively.

The rate of air flow passing perpendicularly through a known area of fabric (a circular test area of 5 cm²) is adjusted to obtain a prescribed air pressure differential between the two fabric surfaces. From this rate of air flow, the air permeability of the fabric is determined using an air permeameter (Frazier Precision Instrument Co.). A rate of air flow higher than 100 cm₃/s/cm2 is considered to be an acceptable level of air permeability.

The test for evaluating the water vapor transmission is carried out using the standard ASTM E96-05 using a customized water vapor diffusion apparatus. One suitable apparatus is manufactured by Sea Engineering Company. The test involves securing the fabric to a beaker containing water with the ungrafted side facing the inside of the beaker. The surface area of the beaker mouth is approximately 30 cm². The mass of water vaporated is determined by weighing the beakers before and after the test to 0.1 mg accuracy. Different tests can be conducted to determine loss of water for different time intervals. Weight loss of water is then plotted against time of the test and water vapor transmission is determined by taking initial slope of the curve (0-10 minutes) that passed through the origin. The acceptable range of water vapor transmission rate is 19-23 g/h/m².

Workers, primarily those in the health care profession, involved in treating and caring for individuals injured or sick, can be exposed to biological liquids capable of transmitting disease. These diseases, which may be caused by a variety of microorganisms, can pose significant risks to life and health. The Occupational Safety and Health Administration, Centers for Disease Control and Prevention, and the Association of Operating Room Nurses have published guidelines including the use of protective barriers to help health care workers reduce their risk of occupational exposure.

To assess the effectiveness of the modified PET fabric for protecting the wearer against contact with synthetic blood, a test is carried out according to ASTM F 1819-04 (Standard Test Methods for Resistance of Materials Used in Protective Clothing to Penetration by Synthetic Blood Using a Mechanical Pressure Technique). Using a special test apparatus, the grafted side of a fabric swatch (14×14 cm) is contacted with synthetic blood under a continuously increasing mechanical pressure until a load of 90.7 kg is applied to a 5.72 cm diameter portion of the swatch achieving a pressure on the tested swatch of 345 kPa. The specimen's non-contact side is observed to determine if visual penetration occurs, and if so, at what mechanical pressure the penetration occurs.

The ability of the fabrics to prevent liquid strike-through and bacterial penetration was measured in accordance with the Association of the Nonwovens Industry (INDA) standard test 80.7a-82: Resistance to Penetration of Bacteria in Saline Solution.I5. This test measures the resistance of fabrics to the penetration of microorganism suspensions under a hydrostatic pressure. After sterilized in an autoclave, Jubilee jars are filled with 480 ml prepared bacteria-containing (E. Coli or S. Aureu) saline solution, producing a 4.5-inch hydrostatic head. Visual strike-through of the inoculated saline solution is recorded when present. After the predetermined time intervals (30 and 60 minutes), the jars are removed. Approximately 15 ml agar are poured into the contaminated Petri dish and placed in an incubator at 37° C. CFUs are counted after 48 and 72 hours exposure. Bacterial counts are used as a measure to determine the effectiveness of the fabric as a barrier to bacterial transmissions. Controls should be completed to ensure that bacteria were present in the solution and that no bacteria other than from the challenge contaminated the dishes.

Textile structures have characteristic interstices (weaves), loops (knits), or voids (nonwovens) that can be utilized as pores for air and water permeation. Since the strength of nonwoven material is low, they are generally laminated to stronger base material to be applied as clothing materials. While knitting fabric is easily deformed, commercially available balanced plain woven fabrics having a fabric count of 70×70-100×100 (yarns per inch) is analysed.

When woven fabrics serve as barriers to resist penetration of chemical or biological agents in protective clothing, the fabrics include dense fiber webs with hydrophobic surfaces to reduce absorption and penetration of liquid and small particles. The greater the density and the more closed the fabric structure, the better the protection that is offered to wearers. However, such closed structures create heat stress to wearers at the same time because body generated heat and moisture will be trapped inside, and consequently impede working efficiency. The newly added swelling and self-decontaminating functions on the woven fabrics will enhance biological and chemical protection on the current protective clothing as well as boosting the original barrier functions. With such an addition of protective function, the clothing materials could have increased air permeability, which will reduce heat stress and improve comfort performance to wearers. Balancing protection and comfort is achieved by selecting the degree of grafting, the amount of swelling kinetics/capacity of the grafted polymer network and the strength of so-formed polymer gel.

In another embodiment, the swelling function is included in the protective barrier and the self-decontaminating function is eliminated. In this embodiment, cross-linked polyacrylamide is grafted onto a porous substrate such as polyethylene terephthalate (PET), for example, and no conversion process is performed. Because of its ability to swell reversibly, cross-linked polyacrylamide provides a responsive barrier for materials that include pores provided by weaves, loops or voids without blocking the pores during normal wearing conditions.

Although the protective barrier has primarily been described for use in protective clothing, it will be appreciated by a person skilled in the art that the protective barrier has other applications. For example, protective barriers may be incorporated into bandages or other wound care materials, surgical gowns, surgical drapes, air handling media, filters, building materials including membranes for houses and drapery for home, office or institutions. In addition, many surfaces in high traffic areas such as airplane interiors, office buildings and bus terminals are suitable for protective barriers.

It will be appreciated that the above list is not intended to be limiting and is provided by way of example to show the broad range of applications for the protective barrier described herein.

Specific embodiments have been shown and described herein. However, modifications and variations may occur to those skilled in the art. All such modifications and variations are believed to be within the scope and sphere of the present invention.

1. A protective material comprising:
cross-linked self-decontaminating polymer grafted on a porous substrate, said cross-linked self-decontaminating polymer having been converted after grafting to activate self-decontaminating function;
wherein said cross-linked self-decontaminating polymer reversibly swells to block said porous substrate when said protective material is contacted by liquids.

2. A protective material as claimed in claim 1, wherein the type of pores of said porous substrate are selected from the group consisting of: weaves, loops and voids.

3. A protective material as claimed in claim 2, wherein said porous substrate is a natural fabric.

4. A protective material as claimed in claim 1, wherein cross-linked self-decontaminating polymer is polyacrylamide in which the primary amide has been converted to acyclic N-halamine.

5. A protective material as claimed in claim 1, wherein when said porous substrate is a synthetic fabric, a functional group is introduced into said porous substrate to allow a co-initiator to be immobilized onto said porous substrate prior to said cross-linked self-decontaminating polymer being grafted onto said porous substrate.

6. A protective material as claimed in claim 5, wherein said synthetic fabric is selected from the group consisting of: polypropylene, polyester, nylon, Nomex™ and Kevlar™.

7. A protective material as claimed in claim 1, wherein said cross-linked self-decontaminating polymer includes swollen, non-swollen and partially swollen states, said porous substrate being blocked when said cross-linked self-decontaminating polymer is in said swollen state.

8. A method for producing a protective material comprising:
providing a substrate, said substrate having a porous structure;
introducing a functional group into said substrate;
immobilizing a co-initiator onto said substrate;
grafting cross-linked self-decontaminating polymer onto said substrate, said cross-linked self-decontaminating polymer being grafted in a manner that maintains said porous structure of said substrate; and
converting said cross-linked self-decontaminating polymer into an acyclic N-halamine to activate self-decontaminating function of said protective material;
wherein said cross-linked self-decontaminating polymer is a responsive polymer having reversible swelling ability.

9. A method as claimed in claim 8, wherein said cross-linked self-decontaminating polymer swells in response to contact with liquids.

10. A method as claimed in claim 9, wherein said cross-linked self-decontaminating polymer includes swollen, non-swollen and partially swollen states, said substrate being blocked when said cross-linked self-decontaminating polymer is in said swollen state.

11. A method as claimed in claim 8, wherein said porous substrate is selected from the group consisting of: polypropylene, polyester, nylon, Nomex™ and Kevlar™.

12. A protective material comprising:
a porous substrate having converted cross-linked polymer grafted thereon to provide said protective material with reversible swelling ability to vary the permeability of said protective barrier in response to changing hydration of said porous substrate.

13. A protective material as claimed in claim 12, wherein said reversible swelling ability blocks said porous substrate when said protective barrier is contacted by liquids.
